(19) United States
(12) Patent Application Publication
(10) Pub. No.: US 2026/0034819 A1
(43) Pub. Date: Feb. 5, 2026

(54) PRINTED STRUCTURE AND PROCESS FOR PROTECTING THE PRINTED STRUCTURE

(71) Applicant: Lowen Corporation, Hutchinson, KS (US)

(72) Inventors: Tracy Metzger, Hutchinson, KS (US); William Hibbard, White Bear Lake, MN (US)

(73) Assignee: Lowen Corporation, Hutchinson, KS (US)

(21) Appl. No.: 19/288,837

(22) Filed: Aug. 1, 2025

Related U.S. Application Data
(60) Provisional application No. 63/678,518, filed on Aug. 1, 2024.

(51) Int. Cl. B41M 3/06; B41M 5/00; B41M 7/00; C09D 11/40

(52) U.S. Cl. CPC B41M 3/06; B41M 5/0047; B41M 7/0036; C09D 11/40

(57) ABSTRACT

A printed architectural coverings, components and structural elements and a process therefor is presented in compliance with Federal Specification CCC-W-408D for color fastness, durability, and abrasion resistance without compromising the aesthetic quality of the product. A multi-layer structure is created by printing the layers on a base film or substrate. The multi-layered structures can simulate many different materials used in construction and renovation projects, such as wood, tile, brick, and textures found in nature such as leaves, sand and tree bark, for example. A printed clear coat provides a uniform clear top coating on all surfaces of the printed structure that complies with the Federal Specification CCC-W-408D for color fastness, durability, and abrasion resistance without compromising the aesthetic quality of the product.

### CROSS REFERENCE TO RELATED APPLICATION

This application claims the benefit of co-pending application Ser. No. 63/678,518, filed Aug. 1, 2024, entitled PRINTED STRUCTURE AND PROCESS FOR PRINTING STRUCTURE.

### FIELD

The present invention generally relates to printed structures and a process for printing and protecting structures, and more particularly, to printed architectural panels, coverings, components and structural elements and a process therefor.

### BACKGROUND

Engineered panels, boards, siding and coverings are known in the art. These products may be made from a variety of materials including wood fibers, vinyl, plastic, epoxy and other materials that are formed as desired for the target application. For example, composite boards may be used for deck boards or other outdoor structures. Floor panels may be formed from vinyl and include a printed grain pattern to simulate the look of wood. Typically, the wood grain pattern is printed on the substrate using ink akin to an inkjet printer. A clear laminate may be added over the printed surface to protect the surface from wear. Other panel or covering products may include a textured surface formed by stamping or molding the material to simulate a raised grain. The textured surface may be combined with printed ink dyes to further mimic wood, tile or other material.

Vinyl wallcoverings and flooring must comply with the Federal Specification CCC-W-408D for coating compound, color fastness, and abrasion resistance, for example. Compliance with the specification color fastness, durability, and abrasion resistance has been accomplished by applying a clear top coating or film. However, application of a clear top coating by various methods such as spraying to a textured vinyl substrate has resulted in an uneven application of the clear top coating.

When a structure is created by digitally printing multiple layers onto a substrate the resulting structure is voluble to damage due to surface abrasion. To protect the structure, clear coats can be applied by flooding or spraying. Flooding the clear coat over the structure fills the structure's valleys or low points thereby reducing the tactile and visual impact of the structure. Alternatively, when the structure is sprayed with a clear coat, a separate manufacturing process is required and the clear coat still has the tendency to fill the structure's valleys and entrap air bubbles. The clear top coating tends to fill the valleys or low points of the textured substrate, while the peaks of the textured substrate have a much thinner application of the clear top coating. The thin application of the clear top coating compromises the durability of the wallcovering or flooring, and the pooling of the clear top coating in the low points of the textured substrate compromises the aesthetic quality of the material.

The printed structure can be protected with a clear over laminate, however the over laminate cannot conform to structure creating a degraded image with little to no tactile appearance. If a film is applied to the textured vinyl substrate, it is difficult for the film to conform to the texture, particularly the low points, leaving a space between the film and substrate. This results in a compromised durability and aesthetic appearance of the material.

There remains a need for creating a textured surface for wall coverings and other materials that complies with the Federal Specification CCC-W-408D for color fastness, durability, and abrasion resistance without compromising the aesthetic quality of the product.

### SUMMARY

The present invention generally relates to printed structures and a process for printing and protecting structures, and more particularly, to printed architectural coverings, components and structural elements and a process therefor in compliance with Federal Specification CCC-W-408D for color fastness, durability, and abrasion resistance without compromising the aesthetic quality of the product. A multi-layer structure is created by printing the layers on a base film or substrate. The multi-layered structures can simulate many different materials used in construction and renovation projects, such as wood, tile, brick, and textures found in nature such as leaves, sand and tree bark, for example. A printed clear coat provides a uniform clear top coating on all surfaces of the printed structure that complies with the Federal Specification CCC-W-408D for color fastness, durability, and abrasion resistance without compromising the aesthetic quality of the product. Printing the clear coat maintains the structure's integrity by uniformly conforming to the structure's profile and does not degrade the image quality. The printed clear coat offers abrasion resistance while maintaining the structure allowing key materials used in the construction and renovation of buildings and homes to be simulated at a much lower cost and impact on the environment.

### BRIEF DESCRIPTION OF THE DRAWINGS

FIG. 1 is a cross-sectional view of a multi-layered printed structure of the present invention.

FIG. 2 is a simplified print head and carriage for printing a multi-layer structure of the present invention.

FIG. 3 is a flow chart showing the steps for printing a multi-layer structure of the present invention.

Like reference numbers and designations in the various drawings indicate like elements.

### DETAILED DESCRIPTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. Said terminology will include the words specifically mentioned, derivatives thereof and words of a similar import.

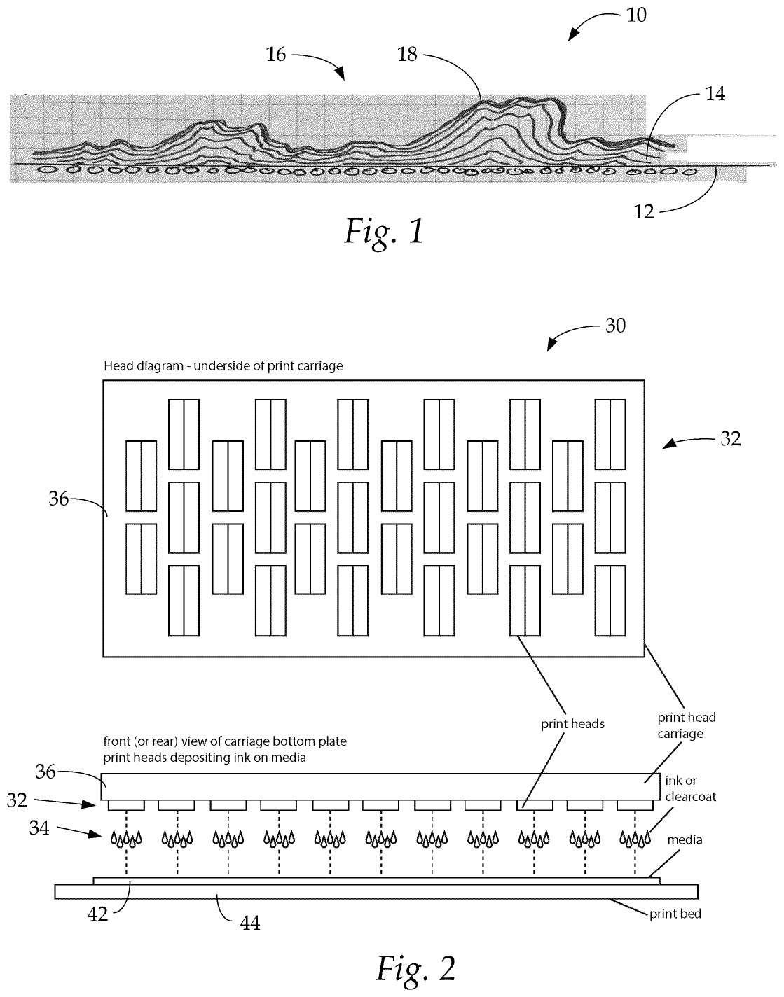

Referring to FIG. 1, multi-layered printed structure of the present invention is generally identified by numeral 10. The multi-layered printed structure 10 shown in FIG. 1 is an example of a cross-section showing the layers of the structure. The multi-layered printed structure 10 includes a base film or substrate 12, multiple layers of printed material 14 forming a desired multi-layered structure 16, and a clear coat 18 uniformly printed over the multi-layered structure 16. The multi-layered structure 16 can simulate many different materials used in construction and renovation projects, consisting of or comprising, but not limited to, wood, tile, brick, stone, and textures found in nature such as leaves, sand, sea shells, and tree bark, for example. The printed clear coat 18 provides a uniform clear top coating on all surfaces of the printed structure 16 that complies with the Federal Specification CCC-W-408D for color fastness, durability, and abrasion resistance without compromising the aesthetic quality of the product. The clear coat 18 may be one to ten mils or more thick to protect the underlying printed structure 16.

Referring to FIG. 2, a simplified printer head and carriage 30 is illustrated. The Printer 30 includes multiple ink and clear coat channels 32 for a continuous ink or clear coat deposit 34 on a substrate 42. The substrate 42 is supported by a platform 44 that may be computer controlled and moved according to the selected multi-layered structure design. The printer head 36 is moved under computer control to define the printed shape. Typically, the printer head 36 moves in a horizontal plane to deposit one layer at a time according to the selected multi-layer structure design. Multiple different ink colors or clear coat materials may be fed through one or more printer heads for the desired design.

A wide variety of media may be printed on, including vinyl (PVC), paper, thermoplastics such as acrylonitrile butadiene styrene (ABS), polylactic acid (PLA), polyethylene terephthalate glycol (PETG), polyethylene terephthalate (PET), Optically Clear polyethylene terephthalate (PET), high-impact polystyrene (HIPS), thermoplastic polyurethane (TPU) and aliphatic polyamides (nylon), for example. In addition, rigid substrates, such as wood, steel, aluminum, carbon fiber, wood fibers, MDF, laminated panels, composites, laminates, lauan, and other materials may be the based media for printing on.

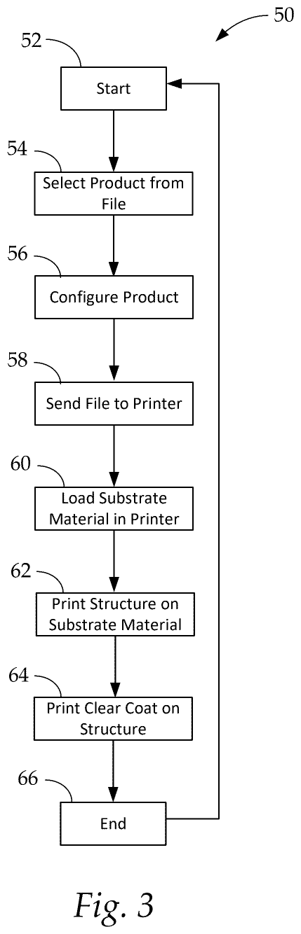

Referring to FIG. 3, a process for printing a multi-layered printed structure of the present invention is generally identified by numeral 50. The process 50 starts at block 52, and a print ready file is selected from a material and pattern database at block 54. The selection may include viewing a variety of available materials and patterns on a computer screen and selecting the desired print. The selection may include selecting from a menu of options to configure the printed product as desired. For example, the menu may include such options to configure the print as desired such choosing a wood, tile, or brick product, block 56. Other options may include oak, maple, or walnut for a wood product, for example. The color or shading of the product may be adjusted as desired. Other options such as a grout color, texture and finish for a brick or tile product may be selected. The substrate that the structure may be printed on may be selected from the menu options.

Once the product is configured, block 56, the corresponding file is sent to the printer, block 58. The desired substrate material is loaded in the printer, block 60, and the selected structure is printed on the substrate, block 62, in as many layers and contours as specified in the product file. Once the structure is printed, a clear coat is printed on the structure, block 64. The clear coat layer uniformly covers the surface of the printed structure. The process may be repeated as many times as desired, or ended, block 66, and returned to the beginning, block 52. Further, the clear coat layer may have a hardness on the Shore D scale of 30 to 75, and preferably 45 to 60. In addition, the structure could be made by printing multiple layers of the clear coat of multiple clear coats with varying properties such as their index of refraction.

As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

Having thus described the invention, what is claimed as new and desired to be secured by Letters Patent is:

1. A multi-layered printed structure comprising:
a base;
at least one layer printed on said base, said layer having a profile;
a clear coat printed on said layer matching said profile, wherein said profile simulates a building material.

2. The multi-layered printed structure of claim 1 wherein said building material is selected from the group comprising wood, tile, brick, stone, grout, marble, concrete and metal.

3. The multi-layered printed structure of claim 1 wherein said building material is selected from the group comprising fabric, leaves, sand, tree bark and shells.

4. The multi-layered printed structure of claim 1 further comprising a plurality of layers successively printed on said base.

5. The multi-layered printed structure of claim 1 wherein the thickness of said clear coat is uniform over the surface of said layer.

6. The multi-layered printed structure of claim 1 wherein the thickness of said clear coat varies as desired over the surface of said layer.

7. The multi-layered printed structure of claim 1 wherein said clear coat protects said layer.

8. The multi-layered printed structure of claim 1 wherein said base is selected from the group comprising vinyl (PVC), paper, thermoplastics such as acrylonitrile butadiene styrene (ABS), polylactic acid (PLA), polyethylene terephthalate glycol (PETG), polyethylene terephthalate (PET), Optically Clear polyethylene terephthalate (PET), high-impact polystyrene (HIPS), thermoplastic polyurethane (TPU) and aliphatic polyamides (nylon), rigid substrates, wood, steel, aluminum, carbon fiber, wood fibers, MDF, laminated panels, composites, laminates, and lauan.

9. The multi-layered printed structure of claim 1 wherein said clear coat has a Shore D hardness of 30 to 75.

10. The multi-layered printed structure of claim 1 wherein said clear coat complies with the Federal Specification CCC-W-408D for color fastness, durability, and abrasion resistance.

11. A method of forming a multi-layered structure comprising the steps of:
selecting a print-ready file from a material and pattern database for a desired structure;
selecting parameters for the structure;
printing one or more layers of material on a substrate according to said selected patterns and parameters; and
printing a clear coat layer on said structure.

12. The method of claim 11 wherein said pattern is selected from the group comprising wood, tile, brick, stone, grout, marble, concrete and metal.

13. The method of claim 11 wherein said pattern is selected from the group comprising fabric, leaves, sand, tree bark and shells.

14. The method of claim 11 wherein said step of printing one or more layers includes printing a plurality of layers successively on said substrate.

15. The method of claim 11 wherein said printing a clear coat layer step includes a thickness of said clear coat layer uniform over the surface of said layers.

16. The method of claim 11 wherein said printing a clear coat layer step includes a thickness of said clear coat layer varies over the surface of said layers.

17. The method of claim 11 wherein said substrate is selected from the group comprising vinyl (PVC), paper, thermoplastics such as acrylonitrile butadiene styrene (ABS), polylactic acid (PLA), polyethylene terephthalate glycol (PETG), polyethylene terephthalate (PET), Optically Clear polyethylene terephthalate (PET), high-impact polystyrene (HIPS), thermoplastic polyurethane (TPU) and aliphatic polyamides (nylon), rigid substrates, wood, steel, aluminum, carbon fiber, wood fibers, MDF, laminated panels, composites, laminates, and lauan.

18. The method of claim 11 wherein said clear coat has a Shore D hardness of 30 to 75.

19. The method of claim 11 wherein said clear coat complies with the Federal Specification CCC-W-408D for color fastness, durability, and abrasion resistance.
